(19) United States
(12) Patent Application Publication
(10) Pub. No.: US 2013/0068419 A1
(43) Pub. Date: Mar. 21, 2013

(54) THERMALLY CONDUCTIVE REINFORCING SHEET, MOLDED ARTICLE AND REINFORCING METHOD THEREOF

(71) Applicants: Takuya Mase, Osaka (JP); Yoshio Terada, Osaka (JP); Midori Tojo, Osaka (JP)

(72) Inventors: Takuya Mase, Osaka (JP); Yoshio Terada, Osaka (JP); Midori Tojo, Osaka (JP)

(73) Assignee: NITTO DENKO CORPORATION, Osaka (JP)

(21) Appl. No.: 13/699,594

(22) PCT Filed: Mar. 25, 2011
(86) PCT No.: PCT/JP2011/061938

§ 371 Date: Nov. 21, 2012

(30) Foreign Application Priority Data
Jul. 2, 2010 (JP) 2010-151699

(51) Int. Cl. F28F 21/08; B32B 37/06; F28F 9/00

(52) U.S. Cl. CPC F28F 21/084; F28F 9/00; B32B 37/06
USPC 165/46; 156/60

(57) ABSTRACT

A thermally conductive reinforcing sheet includes a reinforcing layer. After the thermally conductive reinforcing sheet is attached to an aluminum board having a thickness of 1.0 mm and is heated at 80° C. for 10 minutes, the bending strength at a displacement of 1 mm of the resulting sheet is 10 N or more and the thermal conductivity of the reinforcing layer is 0.25 W/m·K or more.

### TECHNICAL FIELD

The present invention relates to a thermally conductive reinforcing sheet, a molded article and a reinforcing method thereof, to be specific, to a thermally conductive reinforcing sheet, a reinforcing method of a molded article using the thermally conductive reinforcing sheet, and a molded article reinforced by the reinforcing method.

### BACKGROUND ART

Conventionally, in various industrial products, it has been known that in a casing which houses a heating element, for example, a thermally conductive sheet is disposed on the surface of the casing so as to quickly conduct heat generated from the heating element.

As such a thermally conductive sheet, for example, a thermally conductive sheet which contains a silicone copolymer and a thermally conductive filler has been proposed (ref: for example, the following Patent Document 1).

### Prior Art Document.

### Patent Document

Patent Document 1: Japanese Unexamined Patent Publication No. 2010-7039

### SUMMARY OF THE INVENTION

### Problems to be Solved by the Invention

However, there may be a case where a casing is required to have the mechanical strength in accordance with its use and purpose.

However, in the thermally conductive sheet described in the above-described Patent Document 1, there is a disadvantage that the mechanical strength of the casing cannot be sufficiently improved.

It is an object of the present invention to provide a thermally conductive reinforcing sheet which is capable of achieving both excellent thermally conductive properties and excellent reinforcing properties, a molded article in which both of the thermally conductive properties and the mechanical strength are improved, and a reinforcing method of the molded article.

### Solution to the Problems

A thermally conductive reinforcing sheet of the present invention includes a reinforcing layer, wherein after the thermally conductive reinforcing sheet is attached to an aluminum board having a thickness of 1.0 mm and is heated at 80° C. for 10 minutes, the bending strength at a displacement of 1 mm of the resulting sheet is 10 N or more and the thermal conductivity of the reinforcing layer is 0.25 W/m·K or more.

In the thermally conductive reinforcing sheet of the present invention, it is preferable that the adhesive force with respect to an aluminum board, which is obtained by attaching the reinforcing layer to the aluminum board to be heated at 80° C. for 10 minutes and then measured by a 90-degree peel test based on NS Z0237 (in 2000) at a peeling rate of 300 mm/min, is 4 N/25 mm or more.

In the thermally conductive reinforcing sheet of the present invention, it is preferable that the reinforcing layer is formed of a thermally adhesive type pressure-sensitive adhesive composition; it is preferable that the pressure-sensitive adhesive composition contains a polymer of a monomer containing conjugated dienes and/or its hydrogenated polymer and thermally conductive particles; and it is preferable that the pressure-sensitive adhesive composition further contains a tackifier.

In the thermally conductive reinforcing sheet of the present invention, it is preferable that the thermally conductive reinforcing sheet includes a constraining layer laminated on one surface of the reinforcing layer.

A reinforcing method of a molded article of the present invention includes attaching the above-described thermally conductive reinforcing sheet to a molded article to be then heated at 80° C. or more to bring the thermally conductive reinforcing sheet into close contact with the molded article.

In the reinforcing method of a molded article of the present invention, it is preferable that the thermally conductive reinforcing sheet is heated at 80° C. or more in advance and then, the thermally conductive reinforcing sheet is attached to the molded article.

A molded article of the present invention is allowed the above-described thermally conductive reinforcing sheet to be attached thereto to be in close contact with each other.

In the molded article of the present invention, it is preferable that the molded article is at least one casing selected from the group consisting of a casing of household electric appliances, a casing of electrical equipment, and a casing of electronic equipment.

### Effect of the Invention

In the thermally conductive reinforcing sheet of the present invention, the bending strength at a specific temperature is within a specific range and the thermal conductivity within a specific range. Therefore, according to the molded article and the reinforcing method thereof of the present invention, the thermally conductive reinforcing sheet is attached to the molded article to be then heated at a specific temperature to bring the thermally conductive reinforcing sheet into close contact with the molded article, so that the mechanical strength of the molded article is improved and the molded article can be surely reinforced, and the thermally conductive properties of the molded article can be improved.

As a result, both of the mechanical strength and the thermally conductive properties of the molded article of the present invention can be improved.

### BRIEF DESCRIPTION OF THE DRAWINGS

FIG. 1 shows explanatory views for illustrating one embodiment of a reinforcing method of a molded article of the present invention in which a molded article is reinforced by attaching a reinforcing sheet for a molded article of the present invention to the molded article to be brought into close contact therewith:

(a) illustrating a step of preparing a thermally conductive reinforcing sheet to peel off a release film and

(b) illustrating a step of attaching the thermally conductive reinforcing sheet to the molded article to be brought into close contact therewith by heating.

FIG. 2 shows explanatory views for illustrating another embodiment (an embodiment in which a reinforcing sheet for a molded article is formed of a reinforcing layer only) of a reinforcing method of a molded article of the present invention in which a molded article is reinforced by attaching the reinforcing sheet for a molded article of the present invention to the molded article to be brought into close contact therewith:

(a) illustrating a step of preparing a thermally conductive reinforcing sheet to peel off a release film and

(b) illustrating a step of attaching the thermally conductive reinforcing sheet to the molded article to be brought into close contact therewith by heating.

### EMBODIMENT OF THE INVENTION

A thermally conductive reinforcing sheet of the present invention includes a reinforcing layer.

The reinforcing layer is formed from, for example, a pressure-sensitive adhesive composition into a sheet shape.

The pressure-sensitive adhesive composition is a thermally adhesive type and to be specific, exhibits adhesive properties (pressure-sensitive adhesion) by heating at, for example, 80° C. or more.

The pressure-sensitive adhesive composition contains, for example, a polymer component and thermally conductive particles.

The polymer component is a polymer of a monomer containing conjugated dimes and/or its hydrogenated polymer (polymer hydride).

Preferably, the monomer contains the conjugated dienes as essential components and a copolymerizable monomer which is copolymerizable with the conjugated dienes as an arbitrary component.

Examples of the conjugated dienes include 1,3-butadiene, isoprene (2-methyl-1,3-butadiene), and chloroprene (2-chloro-1,3-butadiene).

As the copolymerizable monomer, a monomer having at least one double bond is used. Examples thereof include an aliphatic vinyl monomer (olefins) such as ethylene, propylene, and isobutylene (2-methylpropene); an aromatic vinyl monomer such as styrene; a cyano group-containing vinyl monomer such as (meth)acrylonitrile; and unconjugated dienes such as 1,2-butadiene.

These copolymerizable monomers can be used alone or in combination of two or more. Preferably, an aromatic vinyl monomer is used.

Examples of the polymer of a monomer containing the above-described conjugated dimes include a homopolymer of a monomer consisting of only the above-described conjugated dienes such as polybutadiene, polyisoprene, and a chloroprene polymer (CR) and a copolymer of a monomer consisting of the above-described conjugated dienes and copolymerizable monomer such as an acrylonitrile-butadiene (random) copolymer, a styrene-butadiene-styrene (block) copolymer (SBS), a styrene-butadiene (random) copolymer, a styrene-isoprene-styrene (block) copolymer (SIS), and an isobutylene-isoprene (random) copolymer.

When the polymer is the above-described copolymer, the mixing ratio of the copolymerizable monomer in copolymerization with respect to 100 parts by mass of the total amount of the monomer is, for example, 5 to 50 parts by mass.

The polymers can be used alone or in combination of two or more.

As the polymer, preferably, SBS is used.

In the above-described hydrogenated polymer, an unsaturated bond (a double bond portion) derived from the conjugated dienes is completely hydrogenated or partially hydrogenated. Preferably, an unsaturated bond is completely hydrogenated. To be specific, examples of the hydrogenated polymer include a styrene-ethylene-butylene-styrene (block) copolymer (SEBS), a styrene-ethylene-propylene-styrene (block) copolymer (SEPS), and a styrene-ethylene-tyrene (block) copolymer (SES).

The hydrogenated polymers can be used alone or in combination of two or more.

Of the hydrogenated polymers, preferably, SEBS is used.

The hydrogenated polymer does not substantially contain the unsaturated bond by the above-described hydrogenation of the polymer, so that the hydrogenated polymer is difficult to be thermally deteriorated under a high temperature atmosphere and therefore, the heat resistance of the reinforcing layer can be improved.

The weight average molecular weight (GPC calibrated with polystyrene) of the above-described polymer component is, for example, 20000 or more, or preferably 25000 to 100000.

The Mooney viscosity of the polymer component is, for example, 20 to 80 (ML1+4, at 100° C.), or preferably 30 to 70 (M11+4, at 100° C.).

The viscosity (at 25° C.) of the 25% by mass toluene solution of the polymer component is, for example, 100 to 100000 mPa·s, or preferably 500 to 10000 mPa·s.

The melt flow rate (MFR) of the polymer component is, for example, 10 g/10 min or less at a temperature of 190° C. with a mass of 2.16 kg and is, for example, 20 g/10 min or less at a temperature of 200° C. with a mass of 5 kg.

Of the above-described polymer components, preferably, in view of heat resistance, a hydrogenated polymer is used.

Examples of a thermally conductive material which forms the thermally conductive particles include an inorganic material and an organic material. Preferably, an inorganic material is used.

Examples of the inorganic material include nitride such as boron nitride, aluminum nitride, silicon nitride, and gallium nitride; hydroxide such as aluminum hydroxide and magnesium hydroxide; oxide such as silicon oxide (for example, silica and the like), aluminum oxide (for example, alumina and the like), titanium oxide (for example, titania and the like), zinc oxide, tin oxide (for example, including doped tin oxide such as antimony doped tin oxide), copper oxide, and nickel oxide; carbide such as silicon carbide; carbonate such as calcium carbonate; metal acid salt such as titanate including barium titanate and potassium titanate; and a metal such as copper, silver, gold, nickel, aluminum, and platinum.

As the thermally conductive material, preferably, nitride, hydroxide, and oxide are used, or more preferably, in view of obtaining further excellent thermally conductive properties, furthermore, in view of obtaining electric insulation, boron nitride, aluminum hydroxide, and aluminum oxide are used.

These thermally conductive materials can be used alone or in combination of two or more.

The shape of each of the thermally conductive particles is not particularly limited. Examples of the shape thereof include a bulk shape, a needle shape, a plate shape, a layer shape, and a tube shape.

As the shape of each of the thermally conductive particles, preferably, a bulk shape, a needle shape, and a plate shape are used.

To be specific, examples of the bulk shape include a sphere shape, a rectangular parallelepiped shape, and a pulverized shape.

The size of each of the thermally conductive particles is not particularly limited. In the case of a bulk shape (a sphere shape), the average particle size of the first particle is, for example, 0.1 to 1000 μm, preferably 1 to 100 μm, or more preferably 2 to 50 μm.

The average particle size of each of the thermally conductive particles is an average particle size based on volume obtained by particle size distribution measurement by a laser scattering method. To be specific, the average particle size of each of the thermally conductive particles is obtained by measuring a D50 value (a median size) with a laser scattering particle size analyzer.

When the average particle size of each of the thermally conductive particles is not more than 1000 μm, in the case where the thickness of the reinforcing layer is formed to be below 1000 μm, it can be prevented that the size of each of the thermally conductive particles which forms a bulk exceeds the thickness of the reinforcing layer, causing the occurrence of unevenness in the thickness of the reinforcing layer.

On the other hand, when the average particle size of each of the thermally conductive particles exceeds the above-described range, the average particle size of each of the thermally conductive particles exceeds the desired thickness (described later) of the resin layer, so that the thermally conductive particles may be non-uniformly (dispersedly) dispersed in the pressure-sensitive adhesive composition.

When the shape of each of the thermally conductive particles is a needle shape or a plate shape, the maximum length of the first particle is, for example, 0.1 to 1000 μm, preferably 1 to 100 μm, or more preferably 2 to 50 μm.

The average of the maximum length of each of the thermally conductive particles is an average particle size based on volume obtained by particle size distribution measurement by a laser scattering method. To be specific, the average of the maximum length of each of the thermally conductive particles is obtained by measuring a D50 value (a median size) with a laser scattering particle size analyzer.

When the maximum length of each of the thermally conductive particles is not more than 1000 μm, in the case where the thickness of the reinforcing layer is formed to be below 1000 μm, it can be prevented that the length of each of the thermally conductive particles exceeds the thickness of the reinforcing layer, causing the occurrence of unevenness in the thickness of the reinforcing layer.

On the other hand, when the size of each of the thermally conductive particles exceeds the above-described range, the thermally conductive particles easily aggregate and the handling thereof may become difficult.

The aspect ratio of each the thermally conductive particles, to be specific, the length of the long axis/the length of the short axis when the shape thereof is a needle shape or the diagonal length/the thickness when the shape thereof is a plate shape, is, for example, 10000 or less, or preferably 10 to 1000.

The thermal conductivity of the thermally conductive particles is, for example, 1 W/m·K or more, preferably 2 W/m·K or more, or more preferably 3 W/m·K or more, and is usually 1000 W/m·K or less. The thermal conductivity of the thermally conductive particles is measured by, for example, a hot wire method (a probe method).

A commercially available product can be used as the thermally conductive particles. Examples of the commercially available product include in the boron nitride particles, HP-40 (manufactured by MIZUSHIMA FERROALLOY CO., LTD.) and P1620 (manufactured by Momentive Performance Materials Inc.); in the aluminum hydroxide particles, a HIGILITE series (manufactured by SHOWA DENKO K.K.) such as HIGILITE H-10, HIGILITE H-32, HIGILITE H-42, and HIGILITE H-100-ME; and in the aluminum oxide particles, AS-50 (manufactured by SHOWA DENKO K.K.). Also, examples of the commercially available product of the thermally conductive particles include in the magnesium hydroxide particles, KISUMA 5A (manufactured by Kyowa Chemical Industry Co., Ltd.); in the antimony doped tin oxide particles, an SN-series (manufactured by ISHIHARA SANGYO KAISHA, LTD.) such as SN-100S, SN-100P, and SN-100D (an aqueous dispersion product); and in the titanium oxide particles, a TTO series (manufactured by ISHIHARA SANGYO KAISHA, LTD.) such as TTO-50 and TTO-51 and a ZnO series (manufactured by SUMITOMO OSAKA CEMENT Co., Ltd.) such as ZnO-310, ZnO-350, and ZnO-410.

The thermally conductive particles can be used alone or in combination of two or more.

The mixing ratio of the thermally conductive particles with respect to 100 parts by mass of the polymer component is, for example, 10 to 1000 parts by mass, preferably 50 to 800 parts by mass, or more preferably 100 to 350 parts by mass. When the mixing proportion of the thermally conductive particles exceeds the above-described range, the flexibility of the resin layer is reduced, so that the adhesion force (the adhesion force after heating to be described later) may be reduced. On the other hand, when the mixing proportion of the thermally conductive particles is below the above-described range, the thermally conductive properties may not be sufficiently improved.

Preferably, a tackifier is further contained in the pressure-sensitive adhesive composition.

The tackifier is contained in the pressure-sensitive adhesive composition so as to improve the adhesiveness between the reinforcing layer and the molded article or to improve the reinforcing properties at the time of reinforcement of the molded article.

Examples of the tackifier include a rosin resin, a terpene resin, a coumarone-indene resin, a petroleum resin (for example, a hydrocarbon petroleum resin and the like such as an alicyclic petroleum resin (a cycloalkyl petroleum resin), an aliphatic-aromatic copolymer petroleum resin, and an aromatic petroleum resin), and a phenol resin (for example, a terpene modified phenol resin and the like).

The softening point of the tackifier is, for example, 50 to 150° C., or preferably 50 to 130° C.

The softening point of the tackifier is measured by a ring and ball test,

The tackifiers can be used alone or in combination of two or more.

Of the tackifiers, preferably, a petroleum resin and a phenol resin are used, or more preferably, a petroleum resin is used.

The mixing ratio of the tackifier with respect to 100 parts by mass of the polymer component is, for example, 40 to 200 parts by mass, or preferably 50 to 170 parts by mass.

When the mixing proportion of the tackifier is below the above-described range, there may be a case where the adhesiveness between the reinforcing layer and the molded article cannot be sufficiently improved or the reinforcing properties at the time of reinforcement of the molded article may not be sufficiently improved. When the mixing proportion of the tackifier exceeds the above-described range, the reinforcing layer may become fragile.

In addition to the above-described component, an additive can be also added to the pressure-sensitive adhesive composition. Examples of the additive include fillers, silane coupling agents, oxidation inhibitors, softeners (for example, naphthenic oil, paraffinic oil, and the like), thixotropic agents (for example, montmorillonite and the like), lubricants (for example, stearic acid and the like), pigments, antiscorching agents, stabilizers, antioxidants, ultraviolet absorbers, colorants, fungicides, and flame retardants.

The filler is particles excluding the above-described thermally conductive particles and to be specific, is thermally insulating particles.

Examples of the thermally insulating particles include calcium carbonate (for example, heavy calcium carbonate, light calcium carbonate, Hakuenka, and the like), magnesium silicate (for example, talc and the like), bentonite (for example, organic bentonite and the like), clay, aluminum silicate, and carbon black. The fillers can be used alone or in combination. Preferably, calcium carbonate and carbon black are used.

The thermal conductivity of the filler is usually below 1.0 W/m·K.

The silane coupling agent is blended as required so as to improve the adhesive properties, the durability, and the affinity (the affinity between the polymer component and the thermally conductive particles).

The silane coupling agent is not particularly limited. Examples thereof include an epoxy group-containing silane coupling agent such as 3-glycidoxypropyltrimethoxysilane, 2-glycidoxypropyltriethoxysilane, 3-glycidoxypropylmethyldiethoxysilane, and 2-(3,4-epoxycyclohexyl)ethyltrimethoxysilane; an amino group-containing silane coupling agent such as 3-aminopropyltrimethoxysilane, N-2-(aminoethyl)-3-aminopropylmethyldimethoxysilane, and 3-triethoxysilyl-N-(1,3-dimethyl-butylidene)propylamine; (meth)acrylic group-containing silane coupling agent such as 3-acryloxypropyl trimethoxysilane and 3-methacryloxypropyltriethoxysilane; and an isocyanate group-containing silane coupling agent such as 3-isocyanatepropyltriethoxysilane. The silane coupling agents can be used alone or in combination.

Examples of the oxidation inhibitor include amine-ketones, aromatic secondary amines, phenols, benzimidazoles (for example, 2-mercaptobenzimidazole and the like), thioureas, and phosphorous acids. The oxidation inhibitors can be used alone or in combination. Preferably, benzimidazoles are used.

The addition ratio of the additive with respect to 100 parts by mass of the polymer component is as follows: among all, in the case of the filler, for example, 1 to 200 parts by mass; in the case of the silane coupling agent, for example, 0.01 to 10 parts by mass, or preferably 0.02 to 5 parts by mass; and in the case of the oxidation inhibitor, for example, 0.1 to 5 parts by mass.

The above-described components are blended at the above-described mixing proportion to be stirred and mixed, so that the pressure-sensitive adhesive composition can be prepared.

The reinforcing layer can be formed on the surface (one surface) of the constraining layer and the reinforcing layer can be supported by the constraining layer.

The constraining layer is provided as required so as to impart toughness to the reinforcing layer after being attached and heated. The constraining layer is formed into a sheet shape and is formed of a material which is light in weight, has a thin film, and is capable of being integrally brought into close contact with the reinforcing layer. To be specific, examples of the material include a glass cloth, a resin impregnated glass cloth, a non-woven fabric, a metal foil, a carbon fiber, and a polyester film.

The glass cloth is cloth formed from a glass fiber and a known glass cloth is used.

The resin impregnated glass cloth is obtained by performing an impregnation treatment of a synthetic resin such as a thermosetting resin and a thermoplastic resin into the above-described glass cloth and a known resin impregnated glass cloth is used. Examples of the thermosetting resin include an epoxy resin, a urethane resin, a melamine resin, and a phenol resin. Examples of the thermoplastic resin include a vinyl acetate resin, an ethylene-vinyl acetate copolymer (EVA), a vinyl chloride resin, and an EVA-vinyl chloride resin copolymer. The above-described thermosetting resins and thermoplastic resins can be used alone or in combination, respectively.

An example of the non-woven fabric includes a non-woven fabric formed of a fiber such as a wood fiber (a wood pulp and the like); a cellulose fiber (for example, a regenerated cellulose fiber such as rayon, a semi-synthetic cellulose fiber such as acetate, a natural cellulose fiber such as hemp and cotton, or a blended yarn thereof); a polyester fiber; a polyvinyl alcohol (PVA) fiber; a polyamide fiber; a polyolefin fiber, a polyurethane fiber; and a cellulose fiber (hemp, or hemp and another cellulose fiber).

An example of the metal foil includes a known metal foil such as an aluminum foil and a steel foil.

The carbon fiber is cloth formed from a fiber mainly composed of carbon and a known carbon fiber is used.

Examples of the polyester film include a polyethylene terephthalate film, a polyethylene naphthalate film, and a polybutylene terephthalate film. Preferably, a polyethylene terephthalate film is used.

Of the constraining layers, in view of adhesiveness, strength, and cost, preferably, a resin impregnated glass cloth is used.

The thickness of the constraining layer is, for example, 0.05 to 2.0 mm, or preferably 0.1 to 1.0 mm.

As a method for forming the reinforcing layer on the surface of the constraining layer, a method (a direct forming method) is used in which, for example, the above-described components are dissolved or dispersed in a known solvent (for example, toluene and the like) or water at the above-described mixing proportion to prepare a solution or a dispersion liquid and thereafter, the obtained solution or dispersion liquid are applied to the surface of the constraining layer to be then dried.

Alternatively, as a method for forming the reinforcing layer on the surface of the constraining layer, another method (a transfer method) is used in which, for example, the solution or the dispersion liquid obtained in the description above is applied to the surface of a release film to be described later to be then dried, so that the reinforcing layer is formed to be thereafter transferred to the surface of the constraining layer.

Furthermore, a method (a direct forming method) is also used in which the above-described components (excluding the above-described solvent and water) are directly kneaded with, for example, a mixing roll, a pressurized kneader, an extruder, or the like to prepare a kneaded product and then, the obtained kneaded product is molded into a sheet shape by, for example, a calendar molding, an extrusion molding, a press molding, or the like to form the reinforcing layer to be laminated on the surface of the constraining layer. To be specific, the kneaded product is disposed between the constraining layer and the release film (described later) to be sandwiched and thereafter, they are extended by applying pressure into a sheet shape by, for example, the press molding. Alternatively, another method (a transfer method) is used in which the formed reinforcing layer is laminated on the surface of the release film to be thereafter transferred to the surface of the constraining layer.

The thickness of the reinforcing layer formed in this manner is, for example, 0.02 to 3.0 mm, or preferably 0.03 to 1.3 mm. The thickness of the reinforcing layer can be also set to be, for example, 0.2 to 2.0 mm, or preferably 0.5 to 1.5 mm.

The thickness of the thermally conductive reinforcing sheet obtained in this manner is, for example, 0.25 to 5.0 mm, or preferably 0.4 to 2.3 mm. The thickness of the thermally conductive reinforcing sheet can be also set to be, for example, 0.3 to 3 mm, or preferably 0.3 to 1.8 mm.

When the thickness of the thermally conductive reinforcing sheet exceeds the above-described range, the lightening of the thermally conductive reinforcing sheet may become difficult and the production cost may be increased. When the thickness of the thermally conductive reinforcing sheet is below the above-described range, the reinforcing properties may not be sufficiently improved.

In the obtained thermally conductive reinforcing sheet, the release film (a separator) can be attached to the surface (the surface which is the opposite side with respect to the back surface to which the constraining layer is attached) of the reinforcing layer as required until it is actually used.

Examples of the release film include a known release film such as a synthetic resin film including a polyethylene film, a polypropylene film, and a polyethylene terephthalate film and a paper film laminated with polyethylene or the like.

After the thermally conductive reinforcing sheet (and the reinforcing layer thereof) formed in this manner is attached (i.e. stuck) to an aluminum board having a thickness of 1.0 mm and is then heated at 80° C. for 10 minutes, the bending strength at a displacement of 1 mm of the resulting sheet is 10 N or more, or preferably 12 N or more, and is usually 30 N or less, or preferably 20 N or less.

The bending strength at a displacement of 1 mm described above is measured by a three point bending test. In the test, an aluminum board having a thickness of 1.0 mm reinforced by the thermally conductive reinforcing sheet is trimmed into a size of a length of 150 mm×a width of 25 mm to obtain a test piece. Thereafter, the test piece is pressed from the aluminum board side with a distance between supporting points of 100 mm at a speed of 50 mm/min at the center (the lengthwise center and the widthwise center) of the test piece with an indenter having a diameter of 10 mm using a universal testing machine.

In the attachment (i.e. sticking) of the thermally conductive reinforcing sheet to the aluminum board, the reinforcing layer is brought into contact with the aluminum board.

The bending strength at a displacement of 1 mm of the aluminum board having a thickness of 1.0 mm only is usually about 7.0 N.

The bending strength at a displacement of 1 mm is a bending strength (strength) at the time of displacement of the indenter by 1 mm from the start of the pressing.

When the bending strength at a displacement of 1 mm is within the above-described range, the molded article can be surely reinforced.

In the thermally conductive reinforcing sheet, the adhesive force with respect to the aluminum board, which is obtained by attaching (i.e. sticking) the reinforcing layer to the aluminum board at normal temperature to be heated at 80° C. for 10 minutes and then being measured by a 90-degree peel test at a peeling rate of 300 mm/min, is, for example, 4 N/25 mm or more, preferably 10 N/25 mm or more, or more preferably 50 N/25 mm or more, and is usually 200 N/25 mm or less, preferably 160 N/25 mm or less, or more preferably 100 N/25 mm or less.

The above-described adhesive force is defined as an adhesive force after heating.

The adhesive force after heating is measured in conformity with HS Z0237 (in 2000).

The adhesive force after heating is within the above-described range, so that by heating at relatively low temperature (at 80° C.), the constraining layer and the molded article can be tightly brought into close contact with each other by the reinforcing layer.

The above-described adhesive force of the thermally conductive reinforcing sheet is substantially the same as the corresponding adhesive force of the reinforcing layer.

The thermal conductivity of the reinforcing layer is 0.25 W/m·K or more, preferably 0.30 W/m·K or more, or more preferably 0.45 W/m·K or more, and is usually 10 W/m·K or less.

The thermal conductivity of the reinforcing layer is calculated by the following formula.

Thermal conductivity=(thermal diffusivity)×(heat capacity per unit volume of reinforcing layer)

The thermal diffusivity is measured with a thermal diffusivity measurement device. The heat capacity per unit volume of the reinforcing layer is measured with a differential scanning calorimetry (DSC).

The thermal conductivity of the reinforcing layer is within the above-described range, so that the thermally conductive properties of the molded article can be improved.

The thermally conductive reinforcing sheet of the present invention is used in the reinforcement of the molded article.

The molded article is not particularly limited as long as it is a molded article which requires reinforcement. An example thereof includes a molded article used in various industrial products. To be specific, examples of the molded article include a casing of household electric appliances such as a refrigerator, a washing machine, and an air conditioner's outdoor unit; a casing of electrical equipment such as a motor; and a casing of electronic equipment such as an image display unit including a liquid crystal display and a plasma display and a mobile device including a notebook personal computer.

A material which forms the casing is not particularly limited. Examples of the material include a metal material such as aluminum, stainless steel, iron, copper, gold, silver, chromium, nickel, or alloys thereof and a resin material such as the above-described synthetic resin. As the thermoplastic resin illustrated as the synthetic resin, in addition to the above-described illustration, an olefin resin and the like such as polypropylene and polyethylene are used.

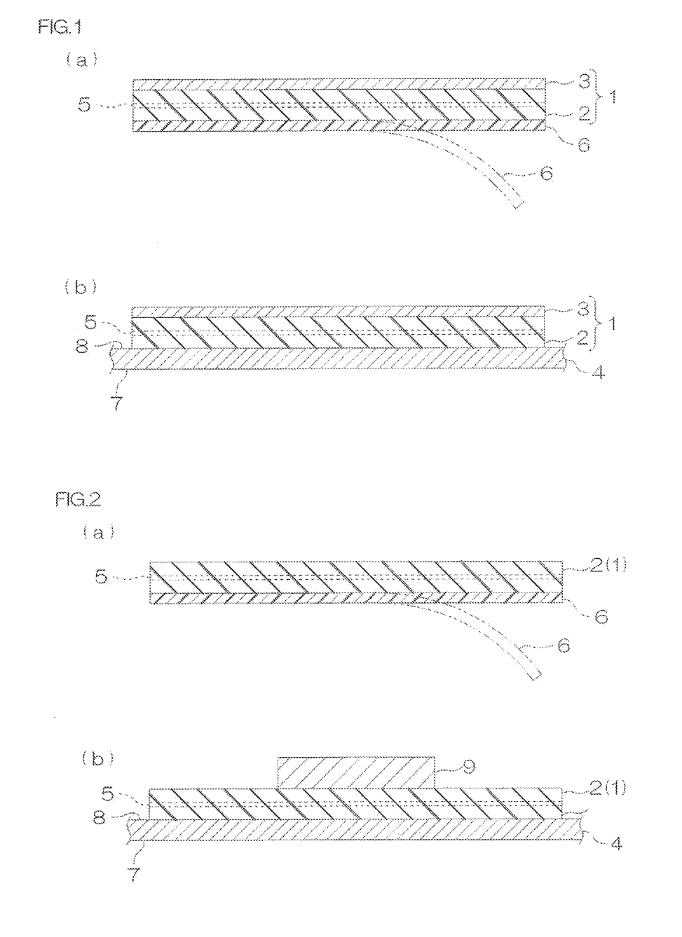

FIG. 1 shows explanatory views for illustrating one embodiment of a reinforcing method of a molded article of the present invention in which a thermally conductive reinforcing sheet of the present invention is attached to a molded article to be brought into close contact therewith.

Next, one embodiment of a reinforcing method of a molded article of the present invention in which a thermally conductive reinforcing sheet of the present invention is attached to a molded article to be brought into close contact therewith is described with reference to FIG. 1.

As shown in FIG. 1(a), in a thermally conductive reinforcing sheet 1, a reinforcing layer 2 is laminated on a constraining layer 3 and a release film 6 is attached to the surface (the surface which is the opposite side with respect to the back surface on which the constraining layer 3 is laminated) of the reinforcing layer 2 as required.

As shown in FIG. 1(b), a molded article 4 is a casing used in the above-described various industrial products. The molded article 4 is provided with, for example, a board-like portion and to be more specific, is formed, in the board-like portion, so as to include an outer surface 7 which appears in the appearance and an inner surface 8 which faces inwardly and does not show in the appearance.

As shown by phantom lines in FIG. 1(a), in order to attach (i.e. stick) the thermally conductive reinforcing sheet 1 to the molded article 4, first, the release film 6 is peeled from the surface of the reinforcing layer 2. Next, as shown in FIG. 1(b), the surface of the reinforcing layer 2 is brought into contact with the inner surface 8 of the molded article 4 and is compressively bonded thereto as required. In the compression bonding of the thermally conductive reinforcing sheet 1, a pressure is applied at a pressure of about, for example, 0.15 to 10 MPa.

In addition, heating (thermal compression bonding) can be also performed with pressurization as required. That is, the thermally conductive reinforcing sheet 1 is heated in advance and then, the heated thermally conductive reinforcing sheet 1 is attached (i.e. stuck) to the molded article 4.

The conditions for the thermal compression bonding are as follows: a temperature of, for example, 80° C. or more, preferably 90° C. or more, or more preferably 100° C.: or more, and usually the heat resistance temperature of the molded article 4 or less, to be specific, for example, 130° C. or less, preferably 30 to 120° C., or more preferably 80 to 110° C.

In this way, the thermally conductive reinforcing sheet I is attached (i.e. stuck) to the molded article 4.

Thereafter, the molded article 4 to which the thermally conductive reinforcing sheet 1 is attached (i.e. stuck) is heated.

The heating temperature is 80° C. or more, preferably 90° C. or more, or more preferably 100° C. or more, and is usually the heat resistance temperature of the molded article 4 or less, to be specific, for example, 130° C. or less, preferably 30 to 120° C., or more preferably 80 to 110° C. The heating duration is, for example, 0.5 to 20 minutes, or preferably 1 to 10 minutes.

When the heating temperature and the heating duration are below the above-described range, there may be a case where the molded article 4 and the constraining layer 3 cannot be sufficiently brought into close contact with each other or the reinforcing properties at the time of the reinforcement of the molded article 4 cannot be sufficiently improved. When the heating temperature and the heating duration exceed the above-described range, the molded article 4 may be deteriorated or melted.

The above-described heating of the molded article 4 is performed by putting the molded article 4 to which the thermally conductive reinforcing sheet 1 is attached (i.e. stuck) into a drying oven in a drying process of production of the molded article 4.

Alternatively, when the drying process is not performed in the production of the molded article 4, the thermally conductive reinforcing sheet 1 only is heated by using a partial heating device such as a heat gun instead of the above-described input into the drying oven.

Alternatively, using the above-described heating device, the molded article 4 only, or furthermore, both of the thermally conductive reinforcing sheet I and the molded article 4 can be heated. When the molded article 4 only is heated, heat of the heating device is thermally conducted to the thermally conductive reinforcing sheet 1.

Then, the thermally conductive reinforcing sheet 1 is attached (i.e. stuck) to the molded article 4 to heat the thermally conductive reinforcing sheet 1 and/or the molded article 4, so that the thermally conductive reinforcing sheet 1 is brought into close contact with the molded article 4.

Thereafter, for example, a component (ref: FIG. 2(b)) which is housed inside the molded article 4 that is not shown and generates heat is disposed on the surface (the inner surface, that is, the surface of the constraining layer 3) of the thermally conductive reinforcing sheet 1. The component which is not shown is directly in contact with the surface of the constraining layer 3.

In the above-described thermally conductive reinforcing sheet 1, the bending strength at a specific temperature is within a specific range and the thermal conductivity is within a specific range. Therefore, the thermally conductive reinforcing sheet 1 is attached (i.e. stuck) to the molded article 4 to be then heated at a specific temperature to bring the thermally conductive reinforcing sheet 1 into close contact with the molded article 4, so that the mechanical strength of the molded article 4 is improved and the molded article 4 can be surely reinforced, and the thermally conductive properties of the molded article 4 can be improved.

As a result, both of the mechanical strength and the thermally conductive properties of the molded article 4 can be improved.

The above-described thermally conductive reinforcing sheet 1 which is shown in FIG. 1 includes the constraining layer 3, so that the mechanical strength of the molded article 4 can be further improved.

On the other hand, in the above-described description in FIG. 1, the constraining layer 3 is included in the thermally conductive reinforcing sheet 1. Alternatively, for example, as shown in FIG. 2(a), the thermally conductive reinforcing sheet 1 can be formed of only the reinforcing layer 2 without including the constraining layer 3.

When the thermally conductive reinforcing sheet 1 is formed of the reinforcing layer 2 only, as shown in FIG. 2(b), a component 9 which is housed inside the molded article 4 and generates heat can be allowed to be directly in contact with the reinforcing layer 2. Therefore, when the component 9 generates heat, the heat can be quickly thermally conducted (dissipated) to the molded article 4 via the reinforcing layer 2.

In the above-described description, the reinforcing layer 2 is formed of one piece of a sheet only made of the pressure-sensitive adhesive composition. Alternatively, for example, as shown by dashed lines in FIGS. 1 and 2, a non-woven fabric 5 can be also interposed partway in the thickness direction of the reinforcing layer 2.

An example of the non-woven fabric 5 includes the same non-woven fabric as that in the description above. The thickness of the non-woven fabric 5 is, for example, 0.01 to 0.3 mm.

In order to produce the thermally conductive reinforcing sheet 1, for example, in the direct forming method, a first reinforcing layer is laminated on the surface of the constraining layer 3 and the non-woven fabric 5 is laminated on the surface (the surface which is the opposite side with respect to the back surface on which the constraining layer 3 is laminated) of the first reinforcing layer. Thereafter, a second reinforcing layer is laminated on the surface (the surface which is the opposite side with respect to the back surface on which the first reinforcing layer is laminated) of the non-woven fabric 5.

In the transfer method, the non-woven fabric 5 is sandwiched from both sides of the surface side and the back surface side of the non-woven fabric 5 by the first reinforcing layer and the second reinforcing layer. To be specific, first, the first reinforcing layer and the second reinforcing layer are respectively formed on the surfaces of two pieces of the release films 6 and then, the first reinforcing layer is transferred to the back surface of the non-woven fabric 5 and the second reinforcing layer is transferred to the surface of the non-woven fabric 5.

By interposing the non-woven fabric 5, the reinforcing layer 2 can be easily formed with a thick thickness in accordance with the strength of the molded article 4 which is required to be reinforced.

### EXAMPLES

The present invention will now be described in more detail by way of Examples and Comparative Examples. However, the present invention is not limited to the following Examples and Comparative Examples.

### Examples 1 to 9 and Comparative Example 1

In accordance with the mixing formulation shown in Table 1, components each were blended by parts by mass basis to be kneaded with a mixing roll heated at 120° C. in advance, so that a kneaded product of a pressure-sensitive adhesive composition was prepared.

Next, the prepared kneaded product of the pressure-sensitive adhesive composition was disposed to be sandwiched between a resin impregnated glass cloth (a constraining layer) having a thickness of 0.18 mm in which an epoxy resin was impregnated and a release film. Thereafter, the kneaded product was extended by applying pressure into a sheet shape by a press molding at 120° C. to fabricate a thermally conductive reinforcing sheet having a thickness of 1.3 mm (ref: FIG. 1(a)). The thickness of the reinforcing layer was 1.12 mm.

### Comparative Examples 2 and 3

Each of the thermally conductive reinforcing sheets in Comparative Examples 2 and 3 was fabricated in the same manner as in Examples 1 to 9 and Comparative Example 1, except that silicone resin-based thermally conductive materials (sheets) 1 and 2 were used as they were as reinforcing layers.

(Evaluation)

The bending strength, the adhesive force, and the thermal conductivity of the thermally conductive reinforcing sheets obtained in Examples 1 to 9 and Comparative Examples 1 to 3 were evaluated as follows. The results are shown in Table 1.

1) Bending Strength of Thermally Conductive Reinforcing Sheet

The thermally conductive reinforcing sheets of Examples 1 to 9 and Comparative Examples 1 to 3 were attached (i.e. stuck) to aluminum boards each having a thickness of 1.0 mm to be then heated at 80° C. for 10 minutes. Thereafter, the bending strength at a displacement of 1 mm of the obtained pieces was measured by a three point bending test.

In the three point bending test, the thermally conductive reinforcing sheet was attached (i.e. stuck) to the aluminum board having a thickness of 1.0 mm to be trimmed into a size of 150 mm×25 mm, so that a test piece was obtained. Thereafter, the test piece was pressed from the aluminum board side with a distance between supporting points of 100 mm at a speed of 50 mm/min at the center (the lengthwise center and the widthwise center) of the test piece with an indenter having a diameter of 10 mm using a universal testing machine (manufactured by Minebea Co., Ltd.).

In the attachment (i.e. sticking) of the thermally conductive reinforcing sheet to the aluminum board, the reinforcing layer was brought into contact with the aluminum board.

The results are shown in Table 1.

When the measurement was performed on the aluminum board having a thickness of 1.0 mm only in which a thermally conductive sheet was not provided in the same manner as described above, the strength at a displacement of 1 mm of the aluminum board was 7.0 (N).

2) Adhesive Force of Reinforcing Layer (Adhesive Force After Heating)

The adhesive force to be described next of the reinforcing layers only formed in Examples 1 to 9 and Comparative Examples 1 to 3 with respect to aluminum boards were measured by a 90-degree peel test based on ITS Z0237 (in 2000) at a peeling rate of 300 mm/min.

<Adhesive Force After Beating>

First, the reinforcing layers only formed in Examples 1 to 9 and Comparative Examples 1 to 3 were attached (i.e. stuck) to aluminum boards at normal temperature (at 25° C.) to be then heated at 80° C. for 10 minutes and thereafter, the adhesive force after heating with respect to the aluminum board was measured. The results are shown in Table 1.

3) Thermal Conductivity of Reinforcing Layer

The thermal diffusivity and the heat capacity per unit volume of the reinforcing layers in Examples 1 to 9 and Comparative Examples 1 to 3 were measured and the thermal conductivity was calculated by multiplying the obtained values.

The thermal diffusivity was measured with a thermal diffusivity and thermal conductivity measurement device (trade name: “ai-Phase Mobile”, manufactured by ai-Phase Co., Ltd.) and the heat capacity was measured with a differential scanning calorimetry (DSC).

The results are shown in Table 1.

TABLE 1

| | | | | | Ex. Comp. Ex. | | | | | |
|---|---|---|---|---|---|---|---|---|---|---|
| | | | | | Ex. 1 | Ex. 2 | Ex. 3 | Ex. 4 | Ex. 5 | Ex. 6 |
| Reinforcing | Polymer | Polymer of Monomer | [symbol] Block | T432 | 50 | 50 | 50 | 50 | 50 | 50 |
| Layer | Component | Containing Conjugated | Copolymer | A | 50 | 50 | 50 | 50 | 50 | 50 |
| ( [symbol] -Adhesive | | Dienes | | | | | | | | |
| Composition) | | Hydro [symbol] Polymer | Styrene-Ethylene- | H1041 | — | — | — | — | — | — |
| | | | Butylene-Styrene | H1052 | — | — | — | — | — | — |
| | | | Block Copolymer | | | | | | | |
| | Thermally | Aluminium Hydroxide Particles | | [symbol] *1 | 100 | 200 | 300 | 400 | 600 | 800 |
| | Conductive | | | [symbol] *2 | — | — | — | — | — | — |
| | Particles | | | [symbol] *3 | — | — | — | — | — | — |
| | T [symbol] | Aliphatic-Aromatic Copolymer | | [symbol] | 60 | 60 | 60 | 60 | 60 | 60 |
| | | Petroleum Resin | | [symbol] | 40 | 40 | 40 | 40 | 40 | 40 |
| | | Alicyclic Petroleum Resin | | ARKON M100 | — | — | — | — | — | — |
| | | | | ARKON P100 | — | — | — | — | — | — |
| | Filler | Carbon Black | | [symbol] | 3 | 3 | 3 | 3 | 3 | 3 |
| | ( [symbol] Particles) | [symbol] Carbonate | | Heavy Calcium | — | — | — | — | — | — |
| | | | | Carbonate | | | | | | |
| | Silicone Resin Based Thermally Conductive Material 1 | | | | — | — | — | — | — | — |
| | Silicone Resin Based Thermally Conductive Material 2 | | | | — | — | — | — | — | — |
| [symbol] | Bending | Strength at Displacement of 1 mm [N] | | 80° C. | 13.9 | 14.8 | 15.2 | 15.3 | 16.0 | 16.4 |
| | Strength | | | After Heating | | | | | | |
| | Adhesive | Adhesive Force After Heating [N25 mm] | | 80° C. | 155.8 | 50.7 | 23.7 | 5.6 | 5.0 | 4.0 |
| | Force | | | Heating for 10 | | | | | | |
| | | | | [symbol] | | | | | | |
| | Thermal | Thermal Conductivity of Reinforcing | | ( [symbol] ) | 0.25 | 0.39 | 0.46 | 0.52 | 0.70 | 0.89 |
| | Conductivity | Layer | | | | | | | | |
| | | | | | Ex. Comp. Ex. | | | | | |
| | | | | | | | | Comp. | Comp. | Comp. |
| | | | | | Ex. 7 | Ex. 8 | Ex. 9 | Ex. 1 | Ex. 2 | Ex. 3 |
| Reinforcing | Polymer | Polymer of Monomer | [symbol] Block | T432 | 50 | 50 | — | 50 | — | — |
| Layer | Component | Containing Conjugated | Copolymer | A | 50 | 50 | — | 50 | — | — |
| ( [symbol] -Adhesive | | Dienes | | | | | | | | |
| Composition) | | Hydro [symbol] Polymer | Styrene-Ethylene- | H1041 | — | — | 50 | — | — | — |
| | | | Butylene-Styrene | H1052 | — | — | 50 | — | — | — |
| | | | Block Copolymer | | | | | | | |

| | Thermally | Aluminium Hydroxide Particles | [symbol] *1 | — | — | 300 | — | — | — |
|---|---|---|---|---|---|---|---|---|---|
| | Conductive | | [symbol] *2 | 300 | — | — | — | — | — |
| | Particles | | [symbol] *3 | — | 300 | — | — | — | — |
| | T [symbol] | Aliphatic-Aromatic Copolymer | [symbol] | 60 | 60 | — | 60 | — | — |
| | | Petroleum Resin | [symbol] | 40 | 40 | — | 40 | — | — |
| | | Alicyclic Petroleum Resin | ARKON M100 | — | — | 50 | — | — | — |
| | | | ARKON P100 | — | — | 50 | — | — | — |
| | Filler | Carbon Black | [symbol] | 3 | 3 | 3 | 3 | — | — |
| | ( [symbol] Particles) | [symbol] Carbonate | Heavy Calcium | — | — | — | 100 | — | — |
| | | | Carbonate | | | | | | |
| | Silicone Resin Based Thermally Conductive Material 1 | | | — | — | — | — | 100 | — |
| | Silicone Resin Based Thermally Conductive Material 2 | | | — | — | — | — | — | 100 |
| [symbol] | Bending | Strength at Displacement of 1 mm [N] | 80° C. | 14.8 | 14.5 | 14.5 | 13.2 | 7.1 | 7.1 |
| | Strength | | After Heating | | | | | | |
| | Adhesive | Adhesive Force After Heating [N25 mm] | 80° C. | 57.9 | 69.1 | 30.1 | 150.0 | 0.6 | 0.3 |
| | Force | | Heating for 10 | | | | | | |
| | | | [symbol] | | | | | | |
| | Thermal | Thermal Conductivity of Reinforcing | ( [symbol] ) | 0.50 | 0.46 | 0.46 | 0.23 | 1.0 | 1.0 |
| | Conductivity | Layer | | | | | | | |

*1Average particle size, 8 μm
*2Average particle size, [symbol] μm
*3Average particle size, 75 μm [symbol]
indicates data missing or illegible when filed

In Table 1, values for the components in the row of “Reinforcing Layer (Pressure-Sensitive Adhesive Composition)” show number of blended parts by mass.

For the components shown in Table 1, details are given in the following.

T432: trade name “Asaprene T432”, a styrene-butadiene-styrene block copolymer, a ratio of styrene/butadiene: 30/70 (based on mass), a viscosity (at 25° C.) of the 25% by mass toluene solution: 3100 mPa·s, MFR (190° C., 2.16 kg): 0 g/10 min, MFR (200° C., 5 kg): 1 g/10 min below, manufactured by Asahi Kasei Chemicals Corporation

A: trade mime “Tufprene A”, a styrene-butadiene-styrene block copolymer, a ratio of styrene/butadiene: 40/60 (based on mass), a viscosity (at 25° C.) of the 25% by mass toluene solution: 650 mPa·s, MFR (190° C., 2.16 kg): 2.6 g/10 min, MFR (200° C., 5 kg): 13 g/10 min, manufactured by Asahi Kasei Chemicals Corporation

H1041: trade name “Tuftec H1041”, a styrene-ethylene-butylene-styrene block copolymer, a ratio of styrene/(ethylene and butadiene): 30/70 (based on mass), MFR. (190° C., 2.16 kg): 0.3 g/10 min, MFR (200° C., 5 kg): 3 g/10 min, manufactured by Asahi Kasei Chemicals Corporation

H1052: trade name “Tuftec H1052”, a styrene-ethylene-butylene-styrene block copolymer, a ratio of styrene/(ethylene and butadiene): 20/80 (based on mass), MFR (190° C., 2.16 kg): 3 g/10 min, MFR (200° C., 5 kg): 10 g/10 min, manufactured by Asahi Kasei Chemicals Corporation

HIGILITE H-32: trade name, aluminum hydroxide, an average particle size: 8 μm, a bulk shape, a thermal conductivity of 4.5 W/m·K, manufactured by SHOWA DENKO K.K.

HIGILITE H-10: trade name, aluminum hydroxide, an average particle size: 55 μm, a bulk shape, a thermal conductivity of 4.5 W/m·K, manufactured by SHOWA DENKO K.K.

HIGILITE H-100-ME: trade name, aluminum hydroxide, an average particle size: 75 μm, a bulk shape, a thermal conductivity of 4.5 W/m·K, manufactured by SHOWA DENKO K.K.

Petrotack 90HM: trade name, an aliphatic-aromatic copolymer petroleum resin, a softening point (ring and ball test) of 88° C., manufactured by TOSOH CORPORATION

Petrotack 100: trade name, an aliphatic-aromatic copolymer petroleum resin, a softening point (ring and ball test) of 96° C., manufactured by TOSOH CORPORATION

ARKON M100: trade name, an alicyclic petroleum resin, a softening point (ring and ball test) of 100° C., manufactured by Arakawa Chemical Industries, Ltd.

ARKON P100: trade name, an alicyclic petroleum resin, a softening point (ring and ball test) of 100° C., manufactured by Arakawa Chemical Industries, Ltd.

Asahi #50: trade name, carbon black, thermally insulating particles (filler), 70 nm, a bulk shape, manufactured by ASAHI CARBON CO., LTD.

Heavy Calcium Carbonate: a thermal conductivity of 0.6 W/m·K, manufactured by MARUO CALCIUM CO., LTD.

Silicone Resin-Based Thermally Conductive Material 1: trade name “TC-100SP-1.7”, a sheet shape, a thickness of 1.0 mm, manufactured by Shin-Etsu Chemical Co., Ltd.

Silicone Resin-Based Thermally Conductive Material 2: trade name “TC-100THS”, a sheet shape, a thickness of 1.0 mm, manufactured by Shin-Etsu Chemical Co., Ltd.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The thermally conductive reinforcing sheet of the present invention is used in various industrial products which require the heat dissipating properties and the reinforcing properties such as household electric appliances, electrical equipment, an image display unit, electronic equipment, and vehicles.

1. A thermally conductive reinforcing sheet comprising:
a reinforcing layer, wherein
after the thermally conductive reinforcing sheet is attached to an aluminum board having a thickness of 1.0 mm and is heated at 80° C. for 10 minutes, the bending strength at a displacement of 1 mm of the resulting sheet is 10 N or more and the thermal conductivity of the reinforcing layer is 0.25 W/m·K or more.

2. The thermally conductive reinforcing sheet according to claim 1, wherein
the adhesive force with respect to an aluminum board, which is obtained by attaching the reinforcing layer to the aluminum board to be heated at 80° C. for 10 minutes and then measured by a 90-degree peel test based on JIS Z0237 (in 2000) at a peeling rate of 300 mm/min, is 4 N/25 mm or more.

3. The thermally conductive reinforcing sheet according to claim 1, wherein
the reinforcing layer is formed of a thermally adhesive type pressure-sensitive adhesive composition.

4. The thermally conductive reinforcing sheet according to claim 3, wherein
the pressure-sensitive adhesive composition contains a polymer of a monomer containing conjugated dienes and/or its hydrogenated polymer and thermally conductive particles.

5. The thermally conductive reinforcing sheet according to claim 4, wherein the pressure-sensitive adhesive composition further contains a tackifier.

6. The thermally conductive reinforcing sheet according to claim 1, wherein
the thermally conductive reinforcing sheet includes a constraining layer laminated on one surface of the reinforcing layer.

7. A reinforcing method of a molded article comprising:
attaching a thermally conductive reinforcing sheet including a reinforcing layer to a molded article to be then heated at 80° C. or more to bring the thermally conductive reinforcing sheet into close contact with the molded article, wherein
after the thermally conductive reinforcing sheet is attached to an aluminum board having a thickness of 1.0 mm and is heated at 80° C. for 10 minutes, the bending strength at a displacement of 1 mm of the resulting sheet is 10 N or more and the thermal conductivity of the reinforcing layer is 0.25 W/m·K or more.

8. The reinforcing method of a molded article according to claim 7, wherein
the thermally conductive reinforcing sheet is heated at 80° C. or more in advance and then, the thermally conductive reinforcing sheet is attached to the molded article.

9. A molded article allowed a thermally conductive reinforcing sheet including a reinforcing layer to be attached thereto to be in close contact with each other, wherein
after the thermally conductive reinforcing sheet is attached to an aluminum board having a thickness of 1.0 mm and is heated at 80° C. for 10 minutes, the bending strength at a displacement of 1 mm of the resulting sheet is 10 N or more and the thermal conductivity of the reinforcing layer is 0.25 W/m·K or more.

10. The molded article according to claim 9, wherein
the molded article is at least one casing selected from the group consisting of a casing of household electric appliances, a casing of electrical equipment, and a casing of electronic equipment.
